(19) United States
(12) Patent Application Publication
(10) Pub. No.: US 2026/0204829 A1
(43) Pub. Date: Jul. 16, 2026

(54) CONNECTOR

(71) Applicant: Yazaki Corporation, Tokyo (JP)

(72) Inventors: Yuuhei Takeshita, Makinohara-shi (JP); Koki Iwakura, Makinohara-shi (JP); Ayumu Ishikawa, Fujieda-shi (JP); Moeto Osawa, Fujieda-shi (JP)

(21) Appl. No.: 19/447,492

(22) Filed: Jan. 13, 2026

(30) Foreign Application Priority Data
Jan. 15, 2025 (JP) 2025-005239

(51) Int. Cl. H01R 13/426

(52) U.S. Cl. CPC H01R 13/426

(57) ABSTRACT

This connector includes a female terminal fitting, a housing, and a terminal restriction block. The housing includes a terminal accommodating portion. An insertion port for a mating terminal is formed in the front surface of the terminal accommodating portion, and a female terminal fitting is inserted from the rear side. The terminal restriction block is attached to the housing and the female terminal fitting from a direction intersecting the insertion direction of the female terminal fitting. The terminal restriction block restricts displacement of the female terminal fitting along the insertion direction. An outer wall surface intersecting the front surface of the housing is provided with an assembly opening for assembling the terminal restriction block to the housing and the female terminal fitting. A probe insertion hole opened toward the female terminal fitting is formed at a position facing the assembly opening in the housing of the terminal restriction block.

### BACKGROUND OF THE INVENTION

### Field of the Invention

An embodiment of the present invention relates to a connector.

Priority is claimed on Japanese Patent Application No. 2025-005239 filed in Japan on January 15, 2025, the content of which is incorporated herein by reference.

### Description of the Related Art

As a connector used for connection of an electric device, a connector in which a female terminal fitting is accommodated in a resin housing is known (see, for example, Patent Document 1).

In the connector described in Patent Document 1, a female terminal fitting connected to an electric wire is inserted from the rear side of the housing, and the female terminal fitting is accommodated in a terminal holding portion provided inside the housing. An insertion port into which a mating terminal is inserted is formed on a front surface of the terminal holding portion. In addition, a terminal restriction block (spacer) is attached to the housing from a direction intersecting the insertion direction of the female terminal fitting. The terminal restriction block abuts across the housing and the female terminal fitting inside the housing. Displacement of the female terminal fitting inserted into the terminal holding portion of the housing in the front-rear direction in the insertion direction is restricted by the terminal restriction block. Therefore, for example, when the female terminal fitting attempts to move backward due to pulling of the electric wire or the like, the terminal fitting is prevented from moving by the terminal restriction block, and removal of the female terminal fitting from the housing is restricted.

Further, in the connector described in Patent Document 1, a probe insertion hole smaller than the insertion port is formed at an edge of the insertion port on the front surface of the terminal holding portion. The probe insertion hole penetrates the front wall of the terminal holding portion and is opened to face the conducting portion of the female terminal fitting in the terminal holding portion. A conduction inspection probe is inserted into the probe insertion hole after the connector is assembled. The probe can inspect the conduction state of the female terminal fitting by bringing the tip portion into contact with the female terminal fitting.

Patent Document 1: Japanese Unexamined Patent Application, First Publication No. 2011-258568

### SUMMARY OF THE INVENTION

In the connector described in Patent Document 1, a probe insertion hole is formed at an edge of an insertion port on the front surface of the terminal holding portion. However, the front end portion of the female terminal fitting inserted into the terminal holding portion has a structure in which a slight variation in the terminal holding portion is allowed in order to facilitate insertion of the mating terminal. For this reason, in order to reliably bring the conduction inspection probe into contact with the conduction portion of the female terminal fitting, the hole diameter of the probe insertion hole needs to be increased to some extent or more.

However, when the hole diameter of the probe insertion hole is increased, an unexpected short circuit through the probe insertion hole in normal use is more likely to occur.

One embodiment provides a connector capable of suppressing an unexpected short circuit through a probe insertion hole by reducing the hole diameter of the probe insertion hole facing a female terminal fitting as much as possible.

A connector according to one embodiment includes a female terminal fitting connected to an electric wire, a housing including a terminal accommodating portion in which an insertion port for a mating terminal is formed in a front surface and the female terminal fitting is inserted from a rear side, and a terminal restriction block that is attached to the housing and the female terminal fitting from a direction intersecting the insertion direction of the female terminal fitting, and restricts displacement of the female terminal fitting along the insertion direction. An outer wall surface intersecting the front surface of the housing is provided with an assembly opening for assembling the terminal restriction block to the housing and the female terminal fitting. A probe insertion hole opened toward the female terminal fitting is formed at a position facing the assembly opening in the housing of the terminal restriction block.

According to one embodiment, it is possible to suppress an unexpected short circuit through a probe insertion hole by reducing the hole diameter of the probe insertion hole facing a female terminal fitting as much as possible.

### BRIEF DESCRIPTION OF THE DRAWINGS

FIG. 1 is a perspective view of a connector of an embodiment;

FIG. 2 is an exploded perspective view of the connector of the embodiment;

FIG. 3 is a front view of the connector of the embodiment;

FIG. 4 is a partial cross-sectional perspective view of part of the connector of the embodiment;

FIG. 5 is a cross-sectional view taken along line V-V in FIG. 3;

FIG. 6 is a cross-sectional view taken along line VI-VI in FIG. 3;

FIG. 7 is a perspective view of some members of the connector of the embodiment;

FIG. 8 is a bottom view of the connector of the embodiment;

FIG. 9 is a perspective view of a terminal restriction block of the embodiment;

FIG. 10 is an enlarged view of a portion X in FIG. 8; and

FIG. 11 is a cross-sectional view taken along line VI-VI in FIG. 3.

### DETAILED DESCRIPTION OF THE INVENTION

Hereinafter, an embodiment will be described with reference to the drawings.

In the present disclosure, the terms are defined as follows. The term “connection” is not limited to a mechanical connection and may include an electrical connection. That is, the term “connection” is not limited to a case where two elements that are connection targets are directly connected and may include a case where two elements that are connection targets are connected with another element interposed therebetween. “Parallel”, “orthogonal”, or “the same” may include “substantially parallel”, “substantially orthogonal”, or “substantially the same”, respectively.

### Constitution of connector

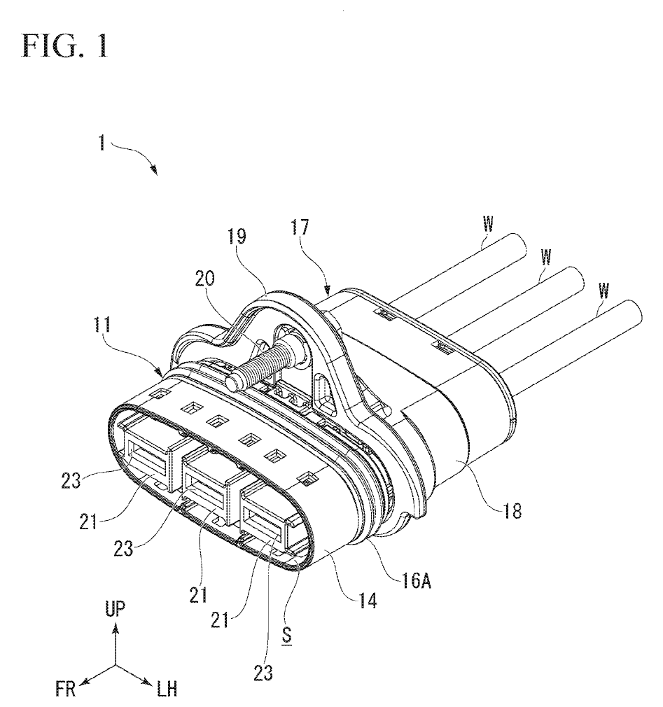

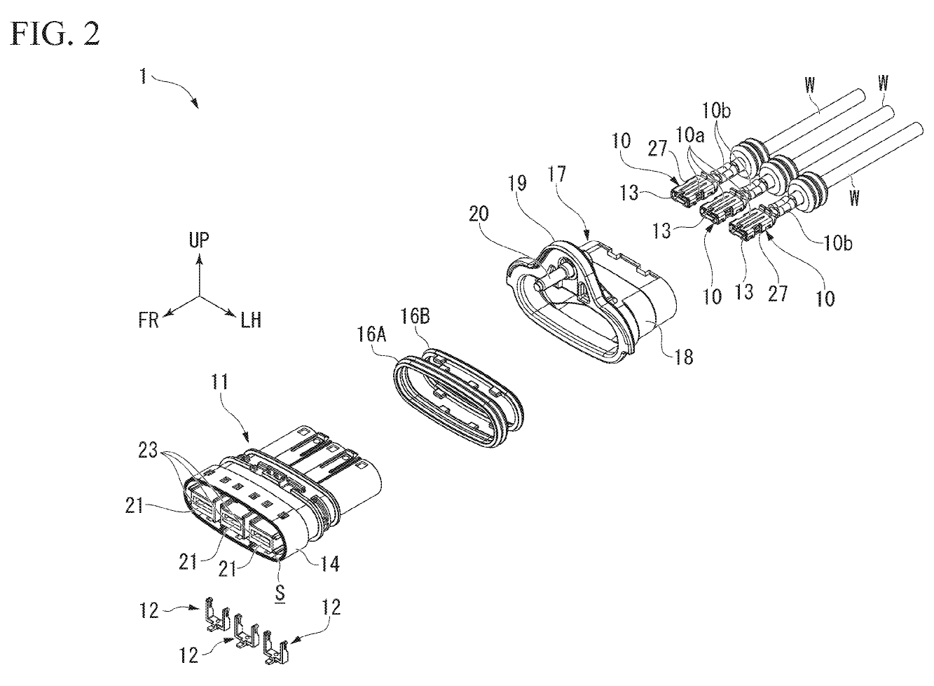

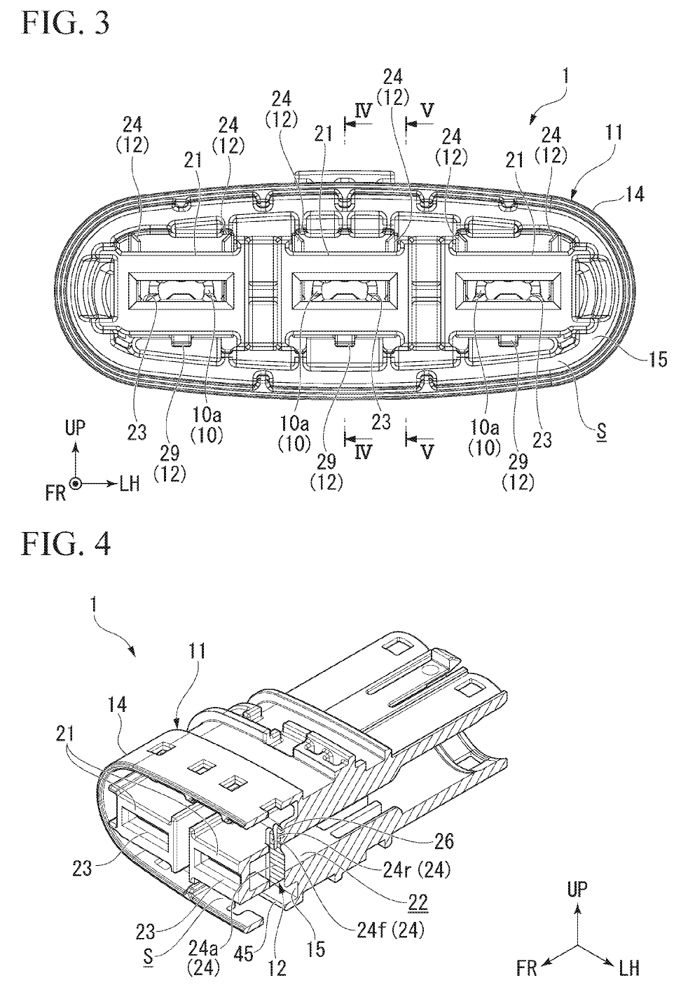

FIG. 1 is a perspective view of a connector 1 of the present embodiment. FIG. 2 is an exploded perspective view of the connector 1. FIG. 3 is a front view of the connector 1.

As illustrated in FIGS. 1 to 3, the connector 1 includes a plurality of female terminal fittings 10 (see FIG. 2) each connected to the end of an electric wire W, a housing 11 in which the plurality of female terminal fittings 10 are accommodated, and a plurality of terminal restriction blocks 12 that restrict displacement of the respective female terminal fittings 10 along the insertion direction. In the present embodiment, three female terminal fittings 10 having the same structure are accommodated in the housing 11. However, the number of female terminal fittings 10 installed in the housing 11 is not limited to three. The number of female terminal fittings 10 installed in the housing 11 may be four or more or two or less.

A mating terminal (male terminal) (not illustrated) can be inserted into the female terminal fitting 10 on one end side in the longitudinal direction (the side opposite to the side to which the electric wire W is connected). The mating terminal is in contact connection with and electrically conducted with the female terminal fitting 10. The female terminal fitting 10 includes a terminal body portion 10a having a long rectangular parallelepiped shape elongated in one direction, and an electric wire connection portion 10b continuously provided to the terminal body portion 10a and connected to an end portion of the electric wire W. In the terminal body portion 10a, an end portion opposite to the electric wire connection portion 10b is opened in a horizontally long rectangular shape. An opening 13 in this portion is an insertion portion into which a mating terminal is inserted.

Hereinafter, for convenience of description, a direction in which the female terminal fitting 10 extends (a direction extending in a long length) when the female terminal fitting 10 is mounted inside the housing 11 is referred to as a “front-rear direction”. Further, in the front-rear direction, a side on which the opening 13 of the female terminal fitting 10 faces is referred to as "front", and a side opposite to the "front" is referred to as "rear". Further, a direction in which the width of the opening 13 of the female terminal fitting 10 is large when the female terminal fitting 10 is mounted inside the housing 11 is referred to as a “width direction”. One side in a direction orthogonal to the front-back direction and the width direction is referred to as “up”, and the other side is referred to as “down”.

An arrow UP pointing upward, an arrow FR pointing forward, and an arrow LH pointing leftward (left side towards the front) are illustrated at appropriate positions in the drawing.

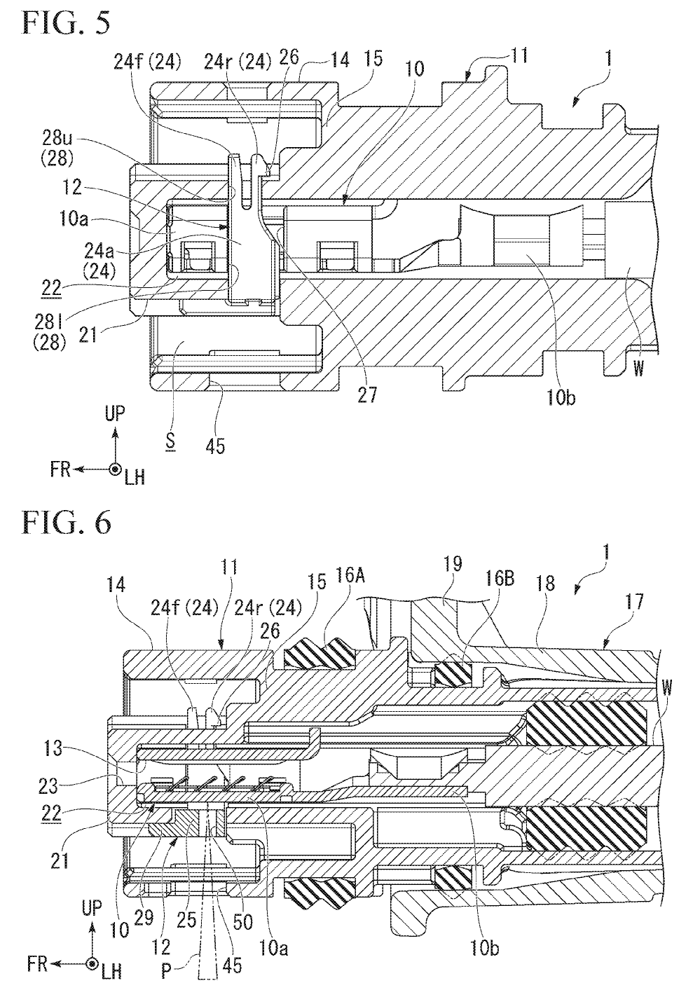

FIG. 4 is a partial cross-sectional perspective view illustrating part of the connector 1 in a cross section. FIG. 5 is a cross-sectional view taken along line V-V in FIG. 3. FIG. 6 is a cross-sectional view taken along line VI-VI in FIG. 3.

The housing 11 includes a peripheral wall 14 having a substantially oval shape in a front view, and a partition wall 15 that partitions the inside of the peripheral wall 14 into front and rear spaces near the front side in the peripheral wall 14.

Two seal members 16A and 16B are mounted on the outer peripheral surface of the peripheral wall 14 while being separated from each other in the front-rear direction.

The seal members 16A and 16B are formed in an oval annular shape. A cylindrical portion of a mating connector (not illustrated) is fitted to an outer peripheral surface of the peripheral wall 14 near the front portion. The seal member 16A on the front side seals between the outer peripheral surface of the peripheral wall 14 near the front portion and the cylindrical portion of the mating connector. A cylindrical portion 18 of a connector cover 17 is fitted to the outer peripheral surface of the peripheral wall 14 near the rear portion. The seal member 16B on the rear side seals between the outer peripheral surface of the peripheral wall 14 near the rear portion and the cylindrical portion 18 of the connector cover 17.

Note that a reference number 19 in FIGS. 1 and 2 denotes a flange portion for fastening provided to the connector cover 17. The flange portion 19 abuts the cover of the mating connector (not illustrated). The flange portion 19 and the cover of the mating connector are fixed to each other by a fastening member such as a bolt 20.

The partition wall 15 is integrally formed with a terminal accommodating portion 21 into which the female terminal fitting 10 is inserted from the rear. As illustrated in FIG. 3, three terminal accommodating portions 21 are provided side by side in a line at the central position of the partition wall 15 in the vertical direction. The terminal accommodating portion 21 is formed in a horizontally long parallelepiped shape. A part of the terminal accommodating portion 21 is formed to protrude toward the front side of the partition wall 15. The three terminal accommodating portions 21 are disposed at regular intervals in the width direction.

In addition, a separation space S is secured between the terminal accommodating portion 21 and the peripheral wall 14 covering the periphery thereof. In each terminal accommodating portion 21, a terminal accommodation chamber 22 opened toward a space on the rear side of the partition wall 15 is formed. The cross-sectional shape of the terminal accommodation chamber 22 (cross-sectional shape orthogonal to the front-rear direction) is a rectangular cross-sectional shape substantially equal to the outer shape of the female terminal fitting 10 (terminal body portion 10a).

Further, a horizontally long rectangular insertion port 23 into which a mating terminal (not illustrated) is inserted is formed on the front surface of each terminal accommodating portion 21. The insertion port 23 penetrates the front wall of the terminal accommodating portion 21 and communicates with the terminal accommodation chamber 22. A mating terminal (not illustrated) is inserted into the female terminal fitting 10 accommodated in the terminal accommodating portion 21 (terminal accommodation chamber 22) through the insertion port 23.

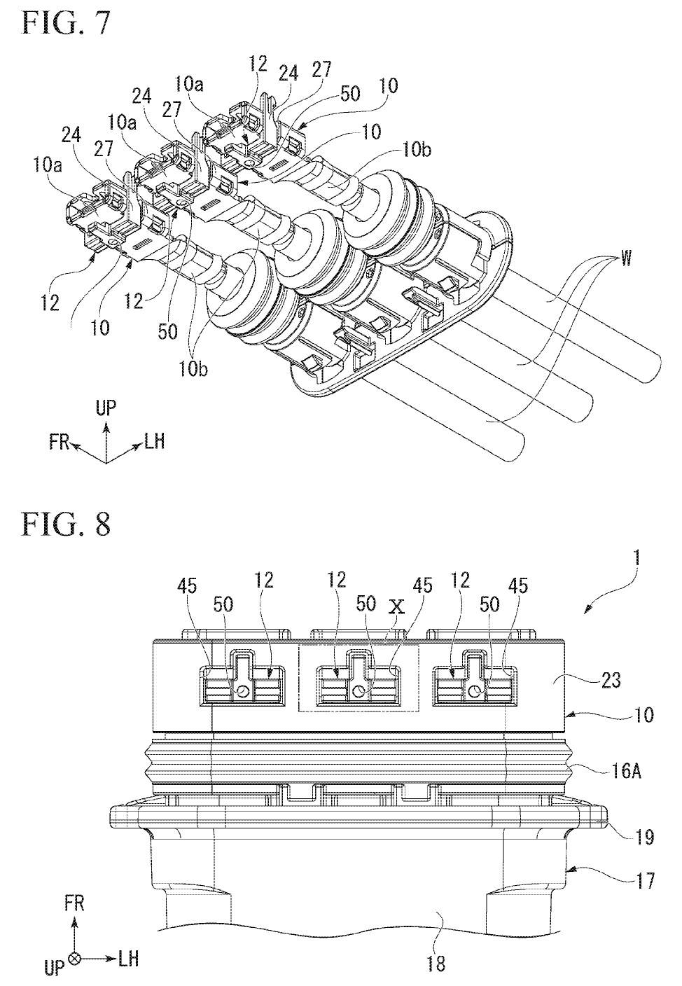

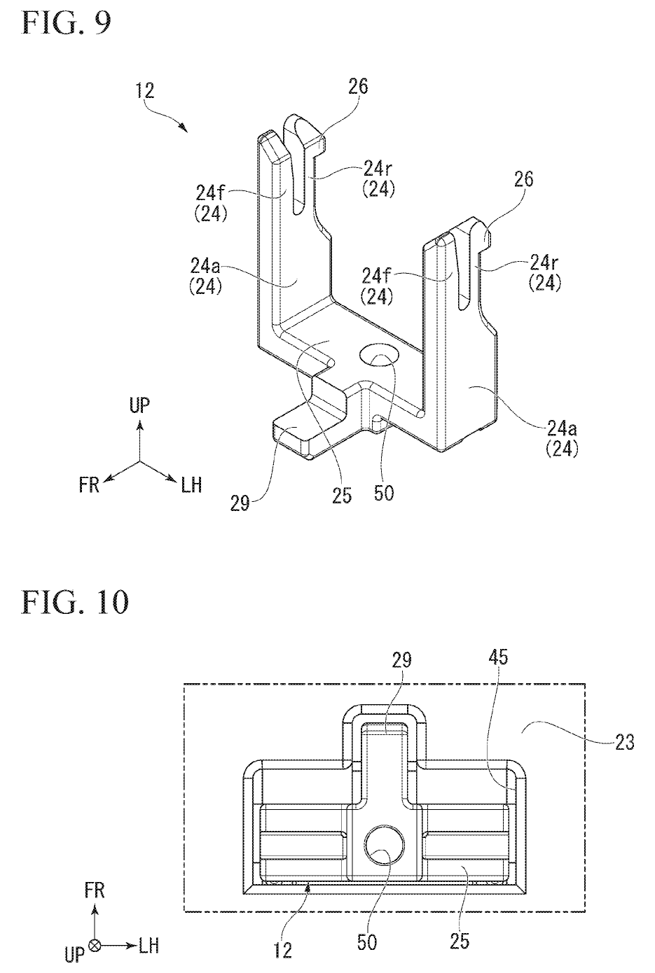

FIG. 7 is a perspective view illustrating a state in which the terminal restriction blocks 12 are attached to three female terminal fittings 10 connected to the electric wires W. FIG. 8 is a view of a front region of the connector 1 as viewed from below. FIG. 9 is a perspective view of the terminal restriction block 12, and FIG. 10 is an enlarged view of a portion X in FIG. 8.

As illustrated in FIG. 9, the terminal restriction block 12 includes a pair of locking walls 24 extending in the vertical direction (direction intersecting the width direction), and a connecting wall 25 that connects lower ends (end portions on the same side) of the pair of locking walls 24 to each other. The terminal restriction block 12 is integrally formed of a resin material having elasticity as a whole.

The pair of locking walls 24 is disposed at a constant interval in the width direction. In a state where the terminal restriction block 12 is attached to the female terminal fitting 10, the pair of locking walls 24 extends in the vertical direction at two positions separated from each other in the width direction of the female terminal fitting 10. Each locking wall 24 is engageable with a recess 27 of the female terminal fitting 10 described later. Each locking wall 24 is formed in a rectangular shape whose horizontal cross section is long in the front-rear direction from the lower end to an intermediate portion region. Hereinafter, this portion is referred to as a "base portion 24a". On the upper side of the base portion 24a of each locking wall 24, a front arm portion 24f and a rear arm portion 24r are provided to protrude side by side in the front-rear direction. The front arm portion 24f and the rear arm portion 24r are continuously formed above the base portion 24a. The front arm portion 24f is formed to have a rectangular cross-sectional shape in substantially the entire region in the vertical direction except for the vicinity of the upper portion. A locking claw 26 protruding toward the rear side is formed on an upper portion of the front arm portion 24f. The rear arm portion 24r is formed to have a rectangular cross-sectional shape in substantially the entire vertical direction.

The width between the outer side surfaces of the left and right locking walls 24 in the width direction is formed to be substantially the same as the width of the terminal body portion 10a of the female terminal fitting 10. An upper region in the base portion 24a of the locking wall 24 can be inserted into the left and right corresponding recesses 27 (see FIG. 5) of the female terminal fitting 10.

As illustrated in FIGS. 4 and 5, a pair of fixing holes 28 penetrating in the vertical direction is formed in a root portion (a portion close to the partition wall 15) of the terminal accommodating portion 21 in a laterally long rectangular parallelepiped shape. The pair of fixing holes 28 is formed at two positions separated in the width direction of the terminal accommodating portion 21. Each fixing hole 28 includes an upper fixing hole 28u penetrating the upper wall of the terminal accommodating portion 21 and a lower fixing hole 28l penetrating the lower wall of the terminal accommodating portion 21. To the left and right fixing holes 28 of each terminal accommodating portion 21, the left and right locking walls 24 of the corresponding terminal restriction block 12 are inserted from below. At this time, the left and right locking walls 24 pass through the corresponding fixing holes 28 while the front arm portion 24f and the rear arm portion 24r on the upper side are compressed in the front-rear direction. Then, when the upper ends of the front arm portion 24f and the rear arm portion 24r pass through the upper end of the fixing holes 28 (upper fixing holes 28u), the locking claw 26 at the upper end of the rear arm portion 24r abuts the upper edge of the upper fixing hole 28u (the upper surface of the terminal accommodating portion 21). At this time, the upper surface of the connecting wall 25 of the terminal restriction block 12 abuts the lower surface of the terminal accommodating portion 21. As a result, the terminal restriction block 12 is fixed to the corresponding terminal accommodating portion 21.

As illustrated in FIGS. 2, 5, and 7, in the female terminal fitting 10, the recesses 27 having a substantially rectangular shape in a top view are formed at left and right side edge portions of the terminal body portion 10a. The recess 27 is formed at a substantially central position in the front-rear direction (longitudinal direction) of the terminal body portion 10a. The recess 27 is recessed in a rectangular shape inward in the width direction from a side end surface of the terminal body portion 10a. The longitudinal width of the recess 27 is formed to be the same as or slightly wider than the longitudinal width of the locking wall 24 of the terminal restriction block 12. The depth of the recess 27 in the width direction is formed to be substantially equal to the length of the locking wall 24 of the terminal restriction block 12 in the width direction.

When assembled in the housing 11, each female terminal fitting 10 is inserted into the corresponding terminal accommodating portion 21 (terminal accommodation chamber 22) from the rear side of the housing 11. At this time, when the female terminal fitting 10 is inserted to a position where the female terminal fitting abuts against the front wall of the terminal accommodating portion 21, the front and rear positions of the left and right recesses 27 of the female terminal fitting 10 coincide with the front and rear positions of the fixing hole 28 of the terminal accommodating portion 21. In this state, when each locking wall 24 of the terminal restriction block 12 is inserted into the fixing hole 28 as described above, the locking wall 24 is disposed inside the corresponding recess 27 of the female terminal fitting 10. At this time, each locking wall 24 of the terminal restriction block 12 abuts or can abut on the inner wall across the fixing hole 28 and the recess 27. As a result, displacement of the female terminal fitting 10 along the insertion direction (front-rear direction) is restricted inside the terminal accommodating portion 21.

As illustrated in FIGS. 6, 9, and 10, a circular probe insertion hole 50 penetrating in the vertical direction is formed at a substantially central position in the width direction of the connecting wall 25 of the terminal restriction block 12. The probe insertion hole 50 is a hole for inserting a conduction inspection probe p (see FIG. 6), and is formed to have an inner diameter slightly larger than an outer diameter of an insertion portion of the probe p. An upper opening of the probe insertion hole 50 faces a lower surface of the female terminal fitting 10 extending in the front-rear direction and the width direction. At a substantially central position in the width direction of the connecting wall 25, an operation piece 29 protruding in a tongue shape toward the front side is continuously provided.

As illustrated in FIGS. 8 and 10, a substantially T-shaped assembly opening 45 is formed in the lower wall in the front region of the peripheral wall 14 of the housing 11. The assembly opening 45 is an opening for assembling the terminal restriction block 12 to the corresponding terminal accommodating portion 21 (housing 11) and the female terminal fitting 10 from below. The assembly opening 45 is formed in a substantially T shape slightly larger than the shape of the terminal restriction block 12 as viewed in a top plan view. The probe insertion hole 50 formed in the connecting wall 25 of the terminal restriction block 12 is formed at a position facing the assembly opening 45 inside the peripheral wall 14 of the housing 11.

In the terminal restriction block 12 attached to the terminal accommodating portion 21 and the female terminal fitting 10 from below the peripheral wall 14 through the assembly opening 45, as illustrated in FIG. 6, the lower surface of the connecting wall 25 is disposed above and away from the position where the assembly opening 45 is formed by a predetermined distance. The probe insertion hole 50 formed in the connecting wall 25 is separated from the assembly opening 45 by a predetermined distance inward (upward) of the peripheral wall 14.

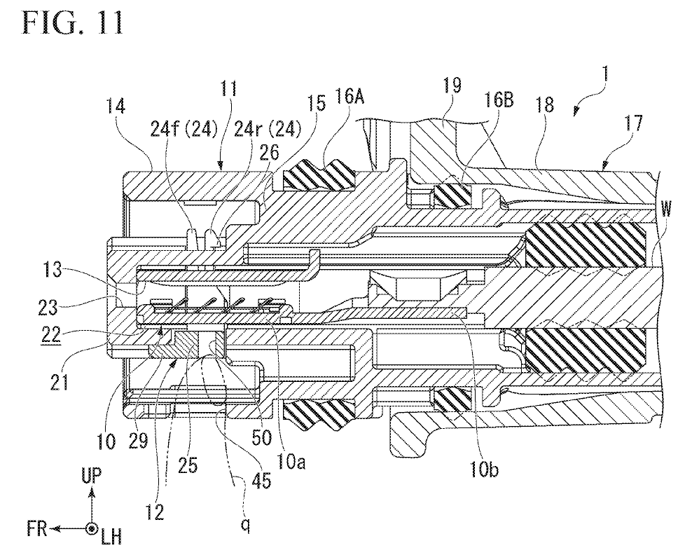

FIG. 11 is a cross-sectional view taken along line VI-VI in FIG. 3 similar to FIG. 6. FIG. 11 illustrates a state in which the tip portion of an article q having an outer diameter larger than that of the probe p is inserted into the assembly opening 45 on the lower surface of the peripheral wall 14 after the connector 1 is assembled.

The probe insertion hole 50 formed in the connecting wall 25 of the terminal restriction block 12 is formed to have an inner diameter slightly larger than the outer diameter of the probe p for conduction as described above. Therefore, as illustrated in FIG. 11, even when the tip portion of the article q is inserted into the assembly opening 45, the tip portion of the article q does not enter the inside of the probe insertion hole 50. For this reason, even if the tip portion of the article q approaches the probe insertion hole 50, an unexpected short circuit through the probe insertion hole 50 does not occur.

### Effects of connector

In the connector 1 of the present embodiment, since the probe insertion hole 50 is formed in the terminal restriction block 12 attached to the housing 11 and the female terminal fitting 10, the probe insertion hole 50 and the female terminal fitting 10 facing the opening of the probe insertion hole 50 are unlikely to be misaligned. For this reason, the conduction inspection probe p inserted into the probe insertion hole 50 can be reliably brought into contact with the female terminal fitting 10 without increasing the hole diameter of the probe insertion hole 50.

Therefore, when the connector 1 of the present embodiment is adopted, the hole diameter of the probe insertion hole 50 facing the female terminal fitting 10 can be reduced as much as possible, and an unexpected short circuit through the probe insertion hole 50 during normal use can be suppressed.

When the connector 1 of the present embodiment is adopted, the conduction inspection probe p can access the probe insertion hole 50 of the terminal restriction block 12 using the assembly opening 45 of the peripheral wall 14 of the housing 11. For this reason, it is not necessary to provide a dedicated hole for inserting the probe p in the housing 11.

Therefore, when the connector 1 of the present embodiment is adopted, the structure of the housing 11 can be simplified, and the manufacturing of the connector 1 can be facilitated.

In the connector 1 of the present embodiment, the terminal restriction block 12 has a constitution including the pair of locking walls 24 and the connecting wall 25. The pair of locking walls 24 extends in a direction intersecting the width direction at two positions separated from each other in the width direction of the female terminal fitting 10. The connecting wall 25 connects the ends on the same side of the pair of locking walls 24 to each other. The pair of locking walls 24 can abut over the respective recesses 27 formed at two positions separated in the width direction of the female terminal fitting 10 and the respective fixing holes 28 formed at two positions separated in the width direction of the terminal accommodating portion 21. The probe insertion hole 50 is formed in the connecting wall 25.

With the above constitution, in the terminal restriction block 12, the pair of locking walls 24 abuts the corresponding recess 27 and the fixing hole 28 of the female terminal fitting 10 and the terminal accommodating portion 21, respectively, thereby restricting displacement of the female terminal fitting 10 in the insertion direction. In addition, since the pair of locking walls 24 of the terminal restriction block 12 abuts the recesses 27 provided at two positions separated from each other in the width direction of the female terminal fitting 10, it is possible to suitably suppress positional deviation of the female terminal fitting 10 with respect to the terminal restriction block 12. In addition, the pair of locking walls 24 abutting on two positions separated in the width direction of the female terminal fitting 10 are connected by the connecting wall 25, and the probe insertion hole 50 is formed in the connecting wall 25. For this reason, the opening of the probe insertion hole 50 reliably faces the intermediate region in the width direction of the female terminal fitting 10.

Therefore, when the above constitution is adopted, even if the hole diameter of the probe insertion hole 50 is reduced, the conduction inspection probe p can be reliably brought into contact with the female terminal fitting 10.

Furthermore, in the connector 1 of the present embodiment, the housing 11 includes the peripheral wall 14 surrounding the outside of the terminal accommodating portion 21, and the separation space S is secured between the peripheral wall 14 and the terminal accommodating portion 21. The assembly opening 45 is formed in the peripheral wall 14 of the housing 11, and the probe insertion hole 50 is disposed at a position spaced apart from the assembly opening 45 inside the peripheral wall 14.

With the above constitution, when the terminal restriction block 12 is attached to the terminal accommodating portion 21 and the female terminal fitting 10, the terminal restriction block 12 can perform an operation through the assembly opening 45 of the peripheral wall 14 of the housing 11. On the other hand, since the assembly opening 45 formed in the peripheral wall 14 needs to allow the terminal restriction block 12 to pass through, the opening area becomes large. However, since the probe insertion hole 50 is disposed apart from the inner side of the peripheral wall 14, the article q and the like other than the probe p hardly come into contact with the edge or the inside of the probe insertion hole 50.

Therefore, when the present constitution is adopted, an unexpected short circuit through the probe insertion hole 50 can be more reliably suppressed.

Although the embodiment of the present disclosure has been described above, the embodiment is shown as an example and is not intended to limit the scope of the present disclosure. This embodiment can be implemented in various other forms, and various omissions, substitutions, and changes can be made without departing from the gist of the present disclosure.

For example, in the above embodiment, the assembly opening 45 for assembling the terminal restriction block 12 is formed in the lower surface of the peripheral wall 14 of the housing 11. However, the portion where the assembly opening 45 is formed is not limited to this portion. The assembly opening 45 may be any portion as long as it is an outer wall surface intersecting the front surface of the housing 11. The assembly opening 45 may be, for example, an upper surface or a side surface of the peripheral wall 14.

In the above embodiment, the terminal restriction block 12 has a shape in which the end portions on the same side of the pair of locking walls 24 are connected by the connecting wall 25, but the shape of the terminal restriction block is not limited to this shape. The terminal restriction block may have any shape as long as displacement along the insertion direction of the female terminal restriction block can be restricted.

In the above embodiment, the entire terminal restriction block 12 is disposed inside the peripheral wall 14 of the housing 11. However, the portion of the terminal restriction block 12 where the probe insertion hole 50 is formed may be exposed through the assembly opening 45.

### REFERENCE SIGNS LIST

1 connector

10 female terminal fitting

11 housing

12 terminal restriction block

14 peripheral wall

21 terminal accommodating portion

23 insertion port

24 locking wall

25 connecting wall

27 recess

28 fixing hole

45 assembly opening

50 probe insertion hole

S separation space

W electric wire

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

What is claimed is:

1. A connector comprising:
a female terminal fitting connected to an electric wire;
a housing including a terminal accommodating portion in which an insertion port for a mating terminal is formed in a front surface and the female terminal fitting is inserted from a rear side; and
a terminal restriction block that is attached to the housing and the female terminal fitting from a direction intersecting an insertion direction of the female terminal fitting, and restricts displacement of the female terminal fitting along the insertion direction, wherein
an outer wall surface intersecting the front surface of the housing is provided with an assembly opening for assembling the terminal restriction block to the housing and the female terminal fitting, and
a probe insertion hole opened toward the female terminal fitting is formed at a position facing the assembly opening in the housing of the terminal restriction block.

2. The connector according to claim 1, wherein
the terminal restriction block includes:
a pair of locking walls extending in a direction intersecting a width direction of the female terminal fitting at two positions separated from each other in the width direction; and
a connecting wall that connects end portions on a same side of the pair of locking walls to each other,
the pair of locking walls is configured to be able to abut over respective recesses formed at two positions separated in the width direction of the female terminal fitting and respective fixing holes formed at two positions separated in a width direction of the terminal accommodating portion, and
the probe insertion hole is formed in the connecting wall.

3. The connector according to claim 2, wherein
the housing includes a peripheral wall surrounding an outer side of the terminal accommodating portion with a separation space between the peripheral wall and the outer side of the terminal accommodating portion,
the assembly opening is formed in the peripheral wall, and
the probe insertion hole is disposed at a position spaced apart from the assembly opening inside the peripheral wall.
